(19) United States
(12) Patent Application Publication
(10) Pub. No.: US 2016/0277790 A1
(43) Pub. Date: Sep. 22, 2016

(54) TRANSMISSION APPARATUS, HYBRIDCAST DATA TRANSMISSION METHOD, RECEPTION APPARATUS, AND HYBRIDCAST DATA RECEPTION METHOD

(71) Applicant: SONY CORPORATION, Minato-ku, Tokyo (JP)

(72) Inventor: YASUHISA NAKAJIMA, KANAGAWA (JP)

(21) Appl. No.: 15/037,790

(22) PCT Filed: Nov. 18, 2014
(86) PCT No.: PCT/JP2014/080562

§ 371 Date: May 19, 2016

(30) Foreign Application Priority Data
Nov. 28, 2013 (JP) 2013-246815

(51) Int. Cl. H04N 21/4363; H04N 21/2665; H04N 21/418; H04N 21/61; H04N 21/84; H04N 21/436; H04N 21/462

(52) U.S. Cl. CPC H04N 21/43635; H04N 21/436; H04N 21/43637; H04N 21/2665; H04N 21/4622; H04N 21/6125; H04N 21/6175; H04N 21/84; H04N 21/418

(57) ABSTRACT

Hybridcast data is allowed to be satisfactorily transferred between apparatuses. A transmission apparatus receives hybridcast-related information from a reception apparatus through a transfer path. The transmission apparatus connects to a hybridcast content server on a communication network on the basis of the hybridcast-related information, acquires hybridcast data, and sends the hybridcast data to the reception apparatus through the transfer path. Also, the transmission apparatus selects the mode of presentation of the hybridcast data on the basis of the hybridcast-related information, and sends the information to the reception apparatus through the transfer path.

### TECHNICAL FIELD

The present invention relates to transmission apparatuses, hybridcast data transmission methods, reception apparatuses, and hybridcast data reception methods. More particularly, the present invention relates to a transmission apparatus for acquiring hybridcast data from a hybridcast content server on a network and transmitting the data to an external apparatus, and the like.

### BACKGROUND ART

In recent years, “hybridcast” services, in which broadcast programs and communication contents are interconnected, have been started. Hybridcast services are intended to provide advanced services by combining digital television broadcasting, which has good broadcasting capability, with communications, which can handle requests from individual viewers.

If additional information relating to a digital television program that is being broadcast is provided through a communication network, such as the Internet or the like, so that the information is presented simultaneously with the broadcast program, more interesting broadcast services can be achieved. For example, multilingual subtitles and audio for foreigners or speed-changed audio for the elderly can be provided. Alternatively, for example, viewers' comments or feedback input to “social network services (SNS),” which are popular on the Internet, can be displayed on a screen showing a broadcast program of interest. Alternatively, for example, a large number of video on demand (VOD) programs provided on the Internet can be recommended to viewers.

In order to provide “hybridcast” services, a digital television receiver needs to be provided with an HTML5 browser for presenting contents acquired from a communication network, an authentication function with a communication network server, and a “video on demand” playback function. In this case, the capacity of flash ROM for storing increasing software and the capacity of DRAM for executing such software increase, leading to an increase in cost, and therefore, the above functions cannot be easily provided in a low-cost digital television receiver.

There have in recent years been an increasing number of digital television receivers equipped with high-definition multimedia interface (HDMI). Note that “HDMI” is a registered trademark. HDMI source apparatuses only for video on demand (VOD), called “HDMI sticks,” which are connected to HDMI, are also available on the market. However, although an “HDMI stick” which supports “hybridcast” services may be conceived of between apparatuses connected by HDMI, it is not guaranteed that such an HDMI stick can be connected to a set that is manufactured by another company, because there are no specifications for control of “hybridcast” services on HDMI.

For example, Patent Literature 1 describes a scheme in which hybridcast-related information is transmitted to an external apparatus, which then executes a control on the basis of the received hybridcast-related information.

### CITATION LIST

### Patent Literature

Patent Literature 1: JP 2013-118614A

### SUMMARY OF INVENTION

### Technical Problem

It is an object of the present technology to allow good transfer of hybridcast data between apparatuses.

### Solution to Problem

A concept of the present technology is a transmission apparatus including: an information reception unit configured to receive hybridcast-related information transmitted from an external apparatus through a transfer path; a communication unit configured to connect to a hybridcast content server on a communication network on the basis of the hybridcast-related information received by the information reception unit, and acquire hybridcast data; a data transmission unit configured to transmit the hybridcast data acquired by the communication unit to the external apparatus through the transfer path; and a presentation-mode information transmission unit configured to transmit presentation-mode information of the hybridcast data transmitted by the data transmission unit, the presentation-mode information being selected on the basis of the hybridcast-related information received by the information reception unit, to the external apparatus through the transfer path.

In the present technology, the information reception unit receives the hybridcast-related information transmitted from the external apparatus through the transfer path. The transfer path is a wired transfer path or a wireless transfer path. Connection to the hybridcast content server on the communication network is established on the basis of the hybridcast-related information so that the hybridcast data is acquired. The hybridcast data includes image data, audio data, text data, and the like. The data transmission unit transmits the hybridcast data to the external apparatus through the transfer path. For example, the data transmission unit may transmit the hybridcast data to the external apparatus through the transfer path using differential signals.

The presentation-mode information transmission unit transmits the presentation-mode information of the hybridcast data transmitted by the data transmission unit, to the external apparatus through the transfer path. For example, the hybridcast-related information may include at least application information table (AIT) information and presentation time stamp (PTS) information.

The presentation-mode information is selected on the basis of the above received hybridcast-related information. For example, the presentation-mode information may include at least either switch information indicating that presentation is to be switched from presentation based on digital broadcast data received by the external apparatus to presentation based on the hybridcast data, or combination information indicating that presentation based on the hybridcast data is to be combined with presentation based on digital broadcast data received by the external apparatus.

For example, the presentation-mode information transmission unit may transmit the presentation-mode information of the hybridcast data transmitted by the data transmission unit, to the external apparatus, with the presentation-mode information being inserted in a blanking period of hybridcast image data transmitted by the data transmission unit. Alternatively, for example, the presentation-mode information transmission unit may transmit the presentation-mode information of the hybridcast data transmitted by the data transmission unit, to the external apparatus through a control data line of the transfer path.

Alternatively, for example, the presentation-mode information transmission unit may transmit the presentation-mode information of the hybridcast data transmitted by the data transmission unit, to the external apparatus through a bidirectional communication path including a predetermined line of the transfer path. In this case, the bidirectional communication path may be a pair of differential transfer paths, and at least one of the pair of differential transfer paths may have a function of being notified of a connection status by the external apparatus using a direct current bias potential. Thus, in the present technology, the hybridcast data acquired on the basis of the hybridcast-related information from the external apparatus, and the presentation-mode information selected on the basis of the hybridcast-related information, are transmitted to the external apparatus. Therefore, the hybridcast data can be satisfactorily transmitted.

Another concept of the present technology is a reception apparatus including: an information transmission unit configured to transmit hybridcast-related information to an external apparatus through a transfer path; a data reception unit configured to receive hybridcast data acquired on the basis of the hybridcast-related information from the external apparatus through the transfer path; a presentation-mode information reception unit configured to receive presentation-mode information of the hybridcast data received by the data reception unit, the presentation-mode information being selected on the basis of the hybridcast-related information, from the external apparatus through the transfer path; and a data processing unit configured to process the hybridcast data received by the data reception unit, on the basis of the presentation-mode information received by the presentation-mode information reception unit, to obtain presentation data.

In the present technology, the information transmission unit transmits the hybridcast-related information to the external apparatus through the transfer path. The transfer path is a wired transfer path or a wireless transfer path. For example, the hybridcast-related information may include at least application information table (AIT) information and presentation time stamp (PTS) information.

The data reception unit receives the hybridcast data acquired on the basis of the hybridcast-related information from the external apparatus through the transfer path. The hybridcast data includes image data, audio data, text data, and the like. For example, the data reception unit may receive the hybridcast data from the external apparatus through the transfer path using differential signals.

The presentation-mode information reception unit receives the presentation-mode information of the hybridcast data received by the data reception unit, the presentation-mode information of the hybridcast data being selected on the basis of the hybridcast-related information, from the external apparatus through the transfer path. For example, the presentation-mode information of the hybridcast data may include at least either switch information indicating that presentation is to be switched from presentation based on received digital broadcast data to presentation based on the hybridcast data, or combination information indicating that presentation based on the hybridcast data is to be combined with presentation based on received digital broadcast data.

For example, the presentation-mode information reception unit may extract the presentation-mode information of the hybridcast data received by the data reception unit, from a blanking period of hybridcast image data received by the data reception unit. Alternatively, for example, the presentation-mode information reception unit may receive the presentation-mode information of the hybridcast data, from the external apparatus through a control data line of the transfer path.

Alternatively, for example, the presentation-mode information reception unit may receive the presentation-mode information of the hybridcast data, from the external apparatus through a bidirectional communication path including a predetermined line of the transfer path. In this case, the bidirectional communication path may be a pair of differential transfer paths, and at least one of the pair of differential transfer paths may have a function of notifying the external apparatus of a connection status using a direct current bias potential.

The data processing unit processes the received hybridcast data on the basis of the received presentation-mode information to obtain the presentation data. The presentation data is image data and/or audio data. For example, the data processing unit obtains the presentation data so that presentation is switched from presentation based on the received digital broadcast data to presentation based on the hybridcast data. Alternatively, the data processing unit obtains the presentation data so that presentation based on the hybridcast data is combined with presentation based on the received digital broadcast data (overlaying for images, mixing for audio).

Thus, in the present technology, hybridcast-related information is transmitted to an external apparatus; hybridcast data acquired on the basis of the hybridcast-related information, and presentation-mode information selected on the basis of the hybridcast-related information, are received from the external apparatus; and the hybridcast data is processed on the basis of the presentation-mode information to obtain presentation data. Therefore, hybridcast data can be satisfactorily received, and therefore, presentation data can be appropriately obtained.

### Advantageous Effects of Invention

According to the present technology, hybridcast data can be satisfactorily transferred between apparatuses. Note that the advantageous effects described herein are merely illustrative and not restrictive, and there may be additional advantageous effects.

### BRIEF DESCRIPTION OF DRAWINGS

FIG. 1 is a block diagram showing a configuration example of an AV system as an embodiment.

FIG. 2 is a diagram showing a schematic example of a hybridcast presentation mode (image overlaying).

FIG. 3 is a diagram showing a schematic example of a hybridcast presentation mode (audio switching).

FIG. 4 is a diagram showing a schematic example of a hybridcast presentation mode (image/audio switching).

FIG. 5 is a diagram showing a schematic example of a hybridcast presentation mode (audio mixing).

FIG. 6 is a diagram showing a schematic example of hybridcast image data transmitted from an HDMI stick to a television receiver through an HDMI transfer path in a case where a hybridcast image is overlaid and presented on a broadcast image.

FIG. 7 is a block diagram showing a configuration example of a data transmission unit of an HDMI stick and a data reception unit of a television receiver.

FIG. 8 is a diagram showing a structure example of TMDS transmission data (in a case where image data of 1920 pixels (width)*1080 lines (height) is transferred).

FIG. 9 is a block diagram showing a configuration example of an HDMI stick.

FIG. 10 is a diagram showing a data structure example of a vendor specific infoframe packet.

FIG. 11 is a block diagram showing a configuration example of a television receiver.

FIG. 12 is a flowchart showing steps of a process of presenting a hybridcast image and audio in an HDMI stick (source apparatus), which is performed when the HDMI stick is connected to a television receiver (sinc apparatus).

FIG. 13 is a flowchart showing steps of a process of presenting a hybridcast image and audio in a television receiver (sinc apparatus), which is performed when the television receiver is connected to an HDMI stick (source apparatus).

FIG. 14 is a diagram showing a schematic example in which a hybridcast service presents a hybridcast image operation display for prompting the user to operate.

### DESCRIPTION OF EMBODIMENTS

Hereinafter, modes for carrying out the present invention (hereinafter referred to as “embodiments”) will be described. Note that description will be provided in the following order.

### 1. Embodiments

### 2. Variations

### 1. Embodiments

### Configuration Example of AV System

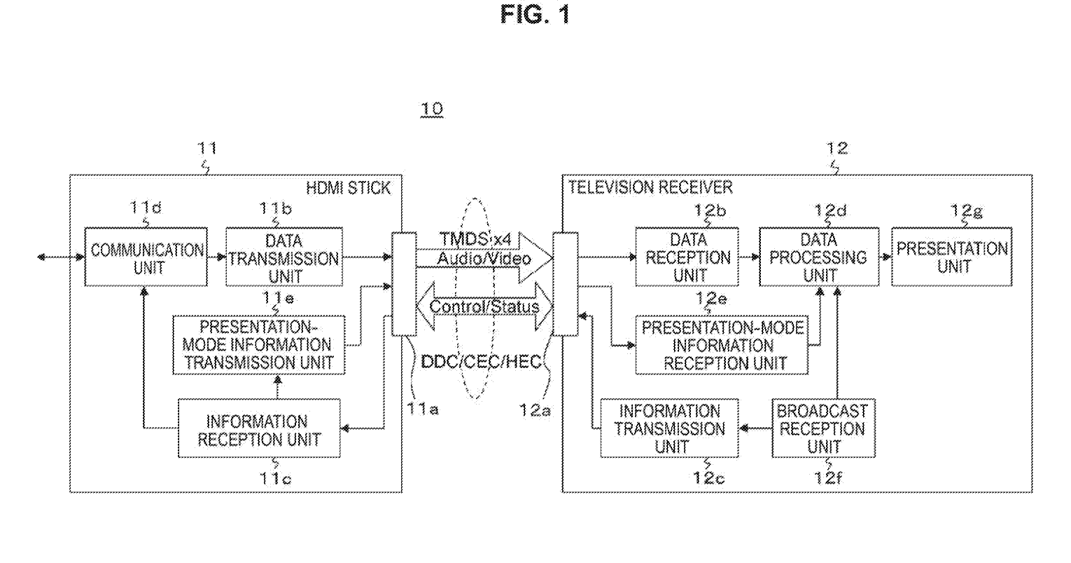

FIG. 1 shows a configuration example of an audio visual (AV) system according to an embodiment. The AV system 10 has an HDMI stick 11 as a source apparatus and a television receiver 12 as a sinc apparatus.

The HDMI stick 11 is provided with an HDMI terminal 11a. Also, the television receiver 12 is provided with an HDMI terminal 12a. The HDMI terminal 11a is connected to the HDMI terminal 12a, so that the HDMI stick 11 is connected to the television receiver 12 by HDMI. In this case, the HDMI terminals 11a and 12a form an HDMI transfer path. Of course, an HDMI cable may be provided between the HDMI terminals 11a and 12a.

Although, here, an example in which the transfer path is HDMI is described, the transfer path may be similarly implemented either as a mobile high-definition link (MHL) transfer path or a wireless radio transfer path, for example.

The HDMI stick 11 has, in addition to the HDMI terminal 11a, a data transmission unit 11b as an HDMI transmission unit, an information reception unit 11c, a communication unit 11d, and a presentation-mode information transmission unit 11e. The information reception unit 11c receives hybridcast-related information from the television receiver 12 through the HDMI transfer path. In this case, the information reception unit 11c receives the hybridcast-related information from the television receiver 12 using, for example, a bidirectional communication path including predetermined lines (e.g., an HPD line and a reserve line) of the HDMI transfer path. The hybridcast-related information contains application information table (AIT) information, presentation time stamp (PTS) information, and the like (see ARIB STD-B24 ver. 5.8).

The communication unit 11d connects to a hybridcast content server on a communication network (not shown), on the basis of the hybridcast-related information received by the information reception unit 11c, to acquire hybridcast data. The hybridcast data contains, for example, image data, audio data, text data, and the like.

The data transmission unit 11b transmits the hybridcast data acquired by the communication unit 11d to the television receiver 12 through the HDMI transfer path. For image data and audio data, the data transmission unit 11b converts compressed data into uncompressed data, and transmits the uncompressed data to the television receiver 12 through the HDMI transfer path using differential signals on a plurality of channels.

Also, for text data, the data transmission unit 11b converts the text data into image data, and transmits the image data to the television receiver 12 through the HDMI transfer path using differential signals on a plurality of channels. Alternatively, for text data, the data transmission unit 11b directly transmits the text data to the television receiver 12 using a bidirectional communication path including predetermined lines (e.g., an HPD line and a reserve line) of the HDMI transfer path.

The presentation-mode information transmission unit 11e transmits the presentation-mode information of hybridcast data transmitted by the data transmission unit 11b, to the television receiver 12 through the HDMI transfer path. The presentation-mode information transmission unit 11e selects the presentation-mode information on the basis of the hybridcast-related information received by the information reception unit 11c. The presentation-mode information transmission unit 11e transmits the presentation-mode information of hybridcast data to the television receiver 12 with the presentation-mode information being inserted in blanking periods of hybridcast image data.

The presentation-mode information contains at least either switch information for switching presentation from presentation based on digital broadcast data received by the television receiver 12 to presentation based on hybridcast data, or combination information for combining presentation based on hybridcast data with digital broadcast data received by the television receiver.

The television receiver 12 has, in addition to the HDMI terminal 12a, a data reception unit 12b as an HDMI reception unit, an information transmission unit 12c, a data processing unit 12d, a presentation-mode information reception unit 12e, a broadcast reception unit 12f, and a presentation unit 12g. The broadcast reception unit 12f receives a digital broadcast to acquire digital broadcast data (image data, audio data). The broadcast reception unit 12f also extracts application information table (AIT) information, presentation time stamp (PTS) information, and the like from a predetermined data broadcast signal.

The information transmission unit 12c transmits hybridcast-related information containing the AIT information, PTS information, and the like extracted by the broadcast reception unit 12f to the HDMI stick 11 through the HDMI transfer path. In this case, the information transmission unit 12c transmits the hybridcast-related information to the HDMI stick 11 using, for example, a bidirectional communication path including predetermined lines (e.g., an HPD line and a reserve line) of the HDMI transfer path.

The data reception unit 12b receives hybridcast data from the HDMI stick 11 through the HDMI transfer path. As described above, the hybridcast data is acquired by the HDMI stick 11 on the basis of the hybridcast-related information transmitted from the information transmission unit 12c to the HDMI stick 11 through the HDMI transfer path.

The data reception unit 12b receives image data and audio data from the HDMI stick 11 through the HDMI transfer path using differential signals on a plurality of channels. The data reception unit 12b receives text data from the HDMI stick 11 using a bidirectional communication path including predetermined lines (e.g., an HPD line and a reserve line) of the HDMI transfer path.

The presentation-mode information reception unit 12e receives the presentation-mode information of hybridcast data received by the data reception unit 12b from the HDMI stick 11 through the HDMI transfer path. As described above, the presentation-mode information is selected by the HDMI stick 11 on the basis of the hybridcast-related information transmitted from the information transmission unit 12c to the HDMI stick 11 through the HDMI transfer path. The presentation-mode information reception unit 12e extracts the presentation-mode information from blanking periods of hybridcast image data.

The data processing unit 12d processes the hybridcast data received by the data reception unit 12b on the basis of the presentation-mode information received by the presentation-mode information reception unit 12e, to acquire presentation data. The presentation data is image data and/or audio data.

As described above, the presentation-mode information contains at least either switch information for switching presentation from presentation based on digital broadcast data received by the television receiver 12 to presentation based on hybridcast data, or combination information for combining presentation based on hybridcast data with digital broadcast data received by the television receiver.

The data processing unit 12d acquires presentation data so that, for example, presentation is switched from presentation based on digital broadcast data received by the broadcast reception unit 12f to presentation based on hybridcast data. Alternatively, the data processing unit 12d acquires presentation data so that, for example, presentation based on hybridcast data is combined with presentation based on digital broadcast data received by the broadcast reception unit 12f (overlaying for images, mixing for audio). Note that the data processing unit 12d converts text data received as hybridcast data into image data (bitmap data), and uses the image data.

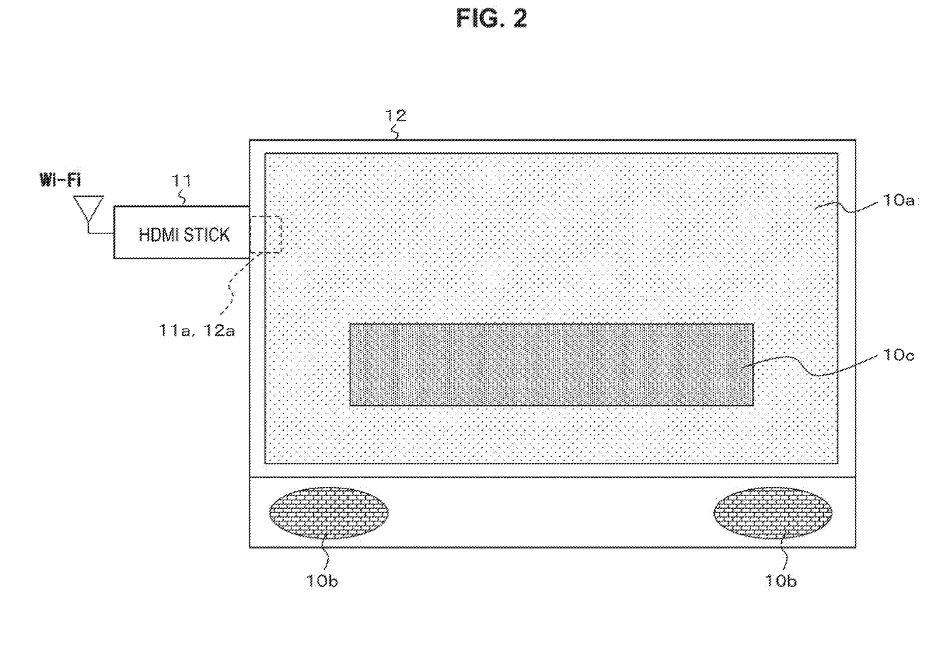

FIG. 2 shows a presentation example of a hybridcast image and audio. This presentation example shows a case where, concerning images, a hybridcast image 10c is overlaid and presented on a broadcast image 10a. Note that, concerning audio, broadcast audio 10b is presented. This presentation example is used, for example, when television program viewers' “tweets,” “voting results,” or the like are displayed.

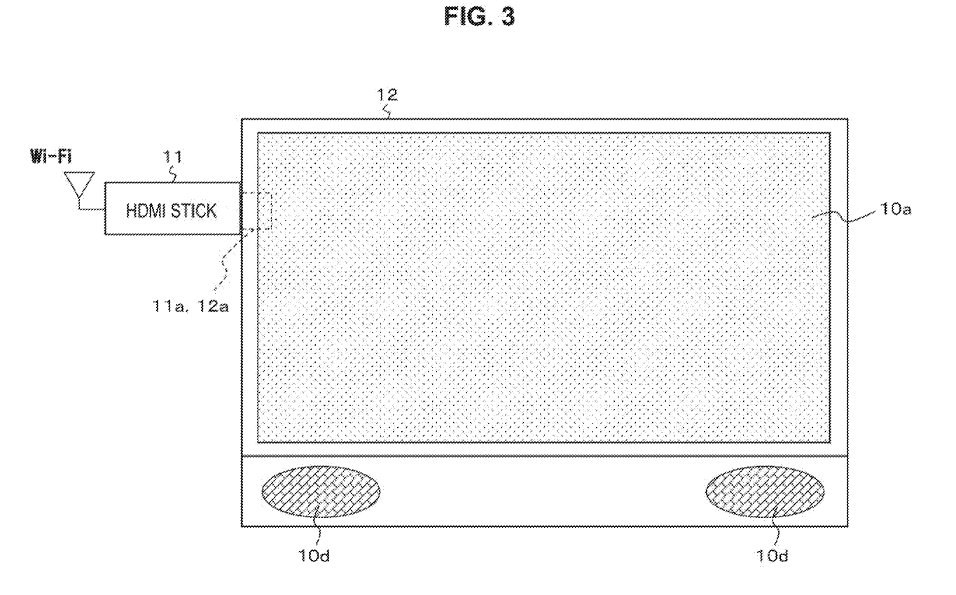

FIG. 3 shows another presentation example of a hybridcast image and audio. This presentation example shows a case where audio presented is switched from the broadcast audio 10b to hybridcast audio 10d. Note that, concerning images, the broadcast image 10a is presented. This presentation example is used, for example, when an audio service is provided in another language which is not used in a television broadcast program, or the like.

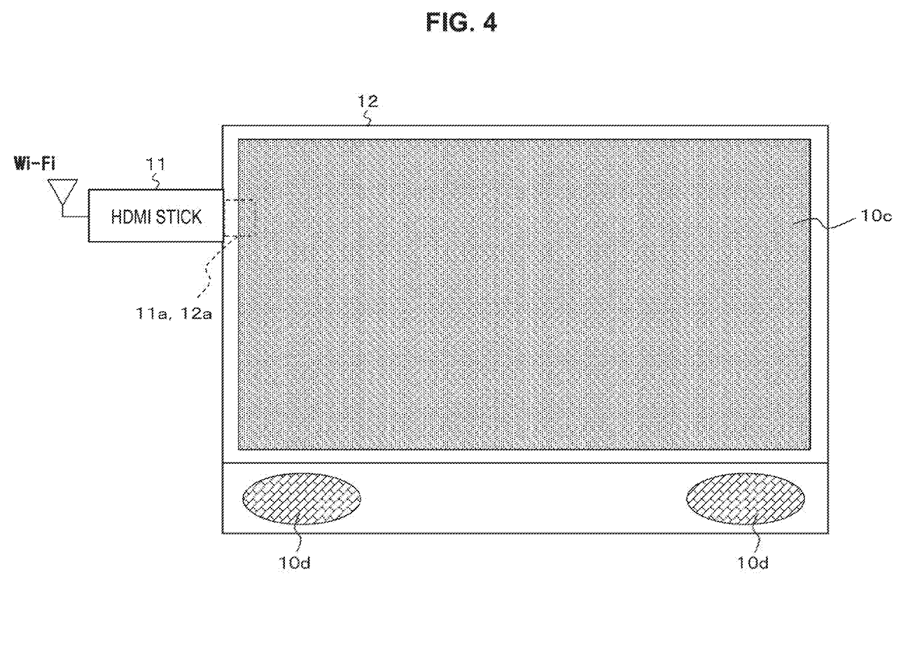

FIG. 4 shows another presentation example of a hybridcast image and audio. This presentation example shows a case where an image presented is switched from the broadcast image 10a to the hybridcast image 10c, and audio presented is switched from the broadcast audio 10b to the hybridcast audio 10d. This presentation example is used, for example, when a VOD content is displayed.

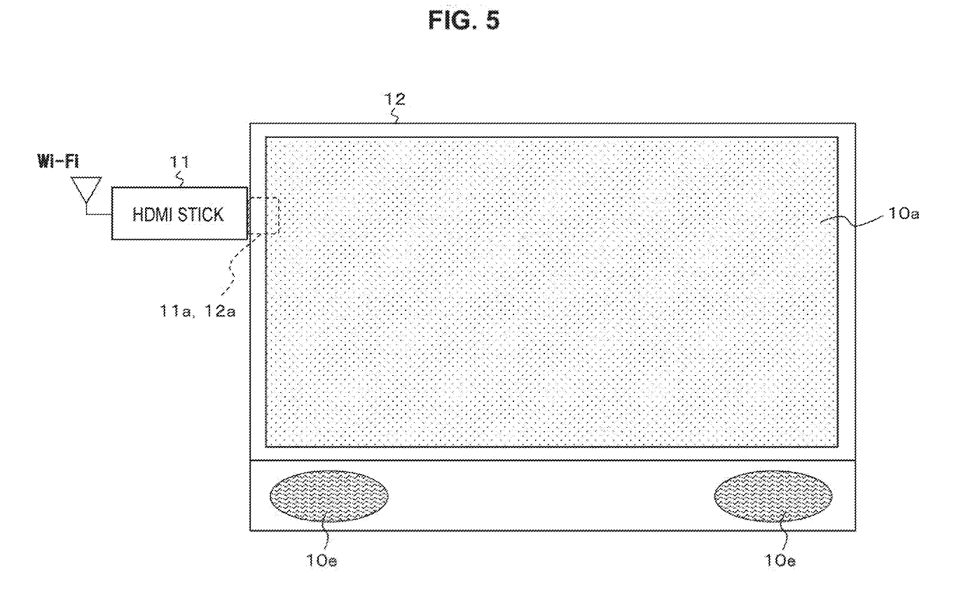

FIG. 5 shows another presentation example of a hybridcast image and audio. This presentation example shows a case where, concerning audio, mixed audio 10e including broadcast audio and hybridcast audio is presented. Note that, concerning images, the broadcast image 10a is presented. This presentation example is used, for example, when broadcast audio which conveys the atmosphere of a site where a sport or the like is being played is mixed with an audio service in another language to increase a sense of realism or the like.

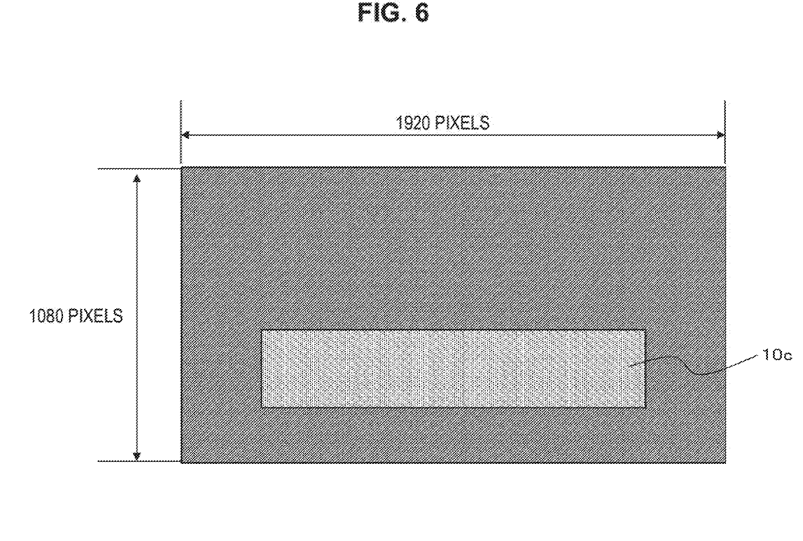

FIG. 6 shows a schematic example of hybridcast image data that is transmitted from the HDMI stick 11 to the television receiver 12 through the HDMI transfer path when the hybridcast image 10c is overlaid and presented on the broadcast image 10a as shown in FIG. 2. In order to reduce the processing load of the overlaying process of the data processing unit 12d of the television receiver 12, the HDMI stick 11 generates hybridcast image data having a resolution at which the television receiver 12 displays. In this case, image data is assumed to have an APL of 0% in an image region where the broadcast image 10a is displayed, and the image data is combined with image data in an image region where the hybridcast image 10c is displayed, to obtain hybridcast image data having a resolution at which the television receiver 12 displays.

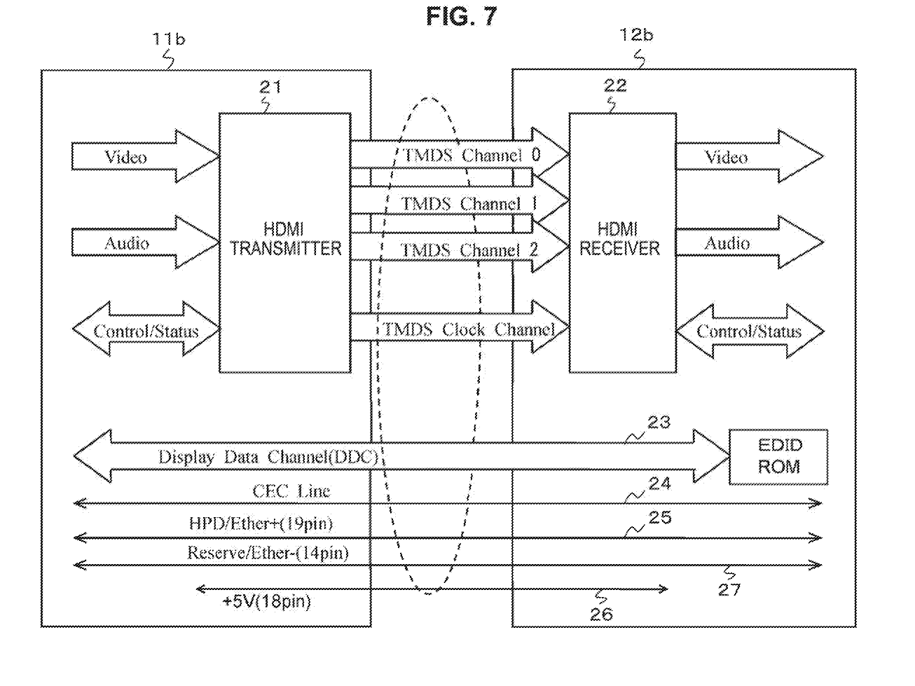

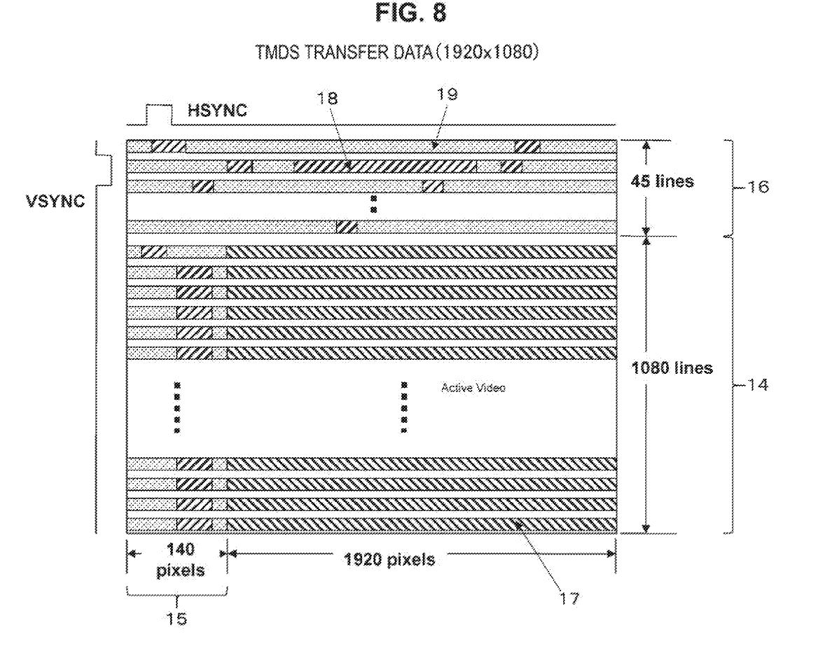

FIG. 7 shows a configuration example of a data transmission unit (HDMI transmission unit) 11b of the HDMI stick 11 and a data reception unit (HDMI reception unit) 12b of the television receiver 12, in the AV system 10 of FIG. 1. The data transmission unit 11b transmits differential signals corresponding to the uncompressed pixel data of an image corresponding to one screen, to the data reception unit 12b through a plurality of channels, in one direction, during an active image interval 14 (hereinafter also referred to as an active video interval, as appropriate) that is an interval from one vertical synchronization signal to the next vertical synchronization signal, excluding a horizontal blanking interval 15 and a vertical blanking interval 16 (see FIG. 8). The data transmission unit 11b transmits differential signals corresponding to at least audio data and control data accompanying an image, other auxiliary data, and the like, to the data reception unit 12b through a plurality of paths, in one direction, during the horizontal blanking interval 15 or the vertical blanking interval 16.

Specifically, the data transmission unit 11b has an HDMI transmitter 21. The transmitter 21 converts, for example, the uncompressed pixel data of an image into corresponding differential signals, and serially transmits the differential signals to the data reception unit 12b in one direction through a plurality of channels, i.e., three transition minimized differential signaling (TMDS) channels #0, #1, and #2.

The transmitter 21 also converts uncompressed audio data accompanying an image, and necessary control data, other auxiliary data, and the like into corresponding differential signals, and serially transmits the differential signals to the data reception unit 12b in one direction through the three TMDS channels #0, #1, and #2. Moreover, the transmitter 21 transmits pixel clocks synchronous with the pixel data transmitted through the three TMDS channels #0, #1, and #2, to the data reception unit 12b through a TMDS clock channel. Here, on one TMDS channel #i (i=0, 1, and 2), 10-bit pixel data is transmitted during one pixel clock.

The data reception unit 12b receives differential signals corresponding to pixel data that are transmitted in one direction from the data transmission unit 11b through a plurality of channels during the active video interval 14 (see FIG. 8). The data reception unit 12b also receives differential signals corresponding to audio data and control data that are transmitted in one direction from the data transmission unit 11b through a plurality of channels during the horizontal blanking interval 15 (see FIG. 8) or the vertical blanking interval 16 (see FIG. 8).

Specifically, the data reception unit 12b has an HDMI receiver 22. The receiver 22 receives, through the TMDS channels #0, #1, and #2, differential signals corresponding to pixel data and differential signals corresponding to audio data and control data that are transmitted in one direction from the data transmission unit 11b, which is connected to the receiver 22 through the HDMI transfer path. At this time, the receiver 22 receives the signals in synchronization with pixel clocks that are transmitted from the same data transmission unit 11b through the TMDS clock channel.

The transfer channels of the HDMI system including the data transmission unit 11b and the data reception unit 12b include, in addition to the three TMDS channels #0-#2 as transfer channels for transmitting pixel data and audio data, and the TMDS clock channel as a transfer channel for transmitting pixel clocks, transfer channels called a display data channel (DDC) 23 and a consumer electronics control (CEC) line 24.

The DDC 23, which includes two lines included in the HDMI transfer path, is used by the data transmission unit 11b to read enhanced extended display identification data (E-EDID) from the data reception unit 12b, which is connected to the data transmission unit 11b through the HDMI transfer path. Specifically, the data reception unit 12b includes, in addition to the HDMI receiver 22, an EDID read only memory (ROM) that stores E-EDID that is performance information about its own performance (configuration and capability).

The data transmission unit 11b reads, through the DDC 23, the E-EDID of the data reception unit 12b from the data reception unit 12b, which is connected to the data transmission unit 11b through the HDMI transfer path. Thereafter, the data transmission unit 11b recognizes, on the basis of the E-EDID, performance settings of the data reception unit 12b, i.e., for example, an image format (profile) (e.g., RGB, YCbCr 4:4:4, YCbCr 4:2:2, etc.) supported by an electronic apparatus having the data reception unit 12b.

The CEC line 24, which includes one line included in the HDMI transfer path, is used for bidirectional communication of control data between the data transmission unit 11b and the data reception unit 12b. The HDMI transfer path also includes a line (HPD line) 25 which is connected to a pin called a hot plug detect (HPD).

A source apparatus can use the line 25 to detect the connection of a sinc apparatus using a direct current bias potential. In this case, the HPD line has a function of being notified of a connection status from a sinc apparatus using a direct current bias potential, as viewed from a source apparatus. Meanwhile, the HPD line has a function of notifying a source apparatus of a connection status using a direct current bias potential, as viewed from a sinc apparatus.

The HDMI transfer path also includes a line (power supply line) 26 that is used to supply power from a source apparatus to a sinc apparatus. The HDMI transfer path also includes a reserve line 27. The HPD line 25 and the reserve line 27 may be used to form a pair of differential transfer paths, which are used as bidirectional communication paths.

FIG. 8 shows intervals during which various items of data are transferred, in a case where image data of 1920 pixels (width)*1080 lines (height) is transferred in the TMDS channels #0, #1, and #2. A video field in which transfer data is transferred through the three TMDS channels #0, #1, and #2 of HDMI, includes three intervals which depend on the type of transfer data, i.e., a video data interval 17 (video data period), a data island interval 18 (data island period), and a control interval 19 (control period).

Here, the video field interval, which is an interval from the active edge of one vertical synchronization signal to the active edge of the next vertical synchronization signal, is divided into a horizontal blanking period 15, a vertical blanking period 16, and an active pixel interval 14 (active video) that is an interval obtained by excluding the horizontal blanking period and the vertical blanking period from the video field interval.

The video data interval 17 is provided in the active pixel interval 14. During the video data interval 17, transferred is the data of active pixels corresponding to 1920 pixels*1080 lines that is uncompressed image data corresponding to one screen. The data island interval 18 and the control interval 19 are provided in the horizontal blanking period 15 and the vertical blanking period 16. During the data island interval 18 and the control interval 19, auxiliary data is transferred.

Specifically, the data island interval 18 is provided in a portion of the horizontal blanking period 15 and a portion of the vertical blanking period 16. During the data island interval 18, for example, audio data packets and the like, which are not involved in control, of the auxiliary data, are transferred. The control interval 19 is provided in the other portion of the horizontal blanking period 15 and the other portion of the vertical blanking period 16. During the control interval 19, for example, a vertical synchronization signal, a horizontal synchronization signal, control packets, and the like, which are involved in control, of the auxiliary data, are transferred.

### Configuration Example of HDMI Stick

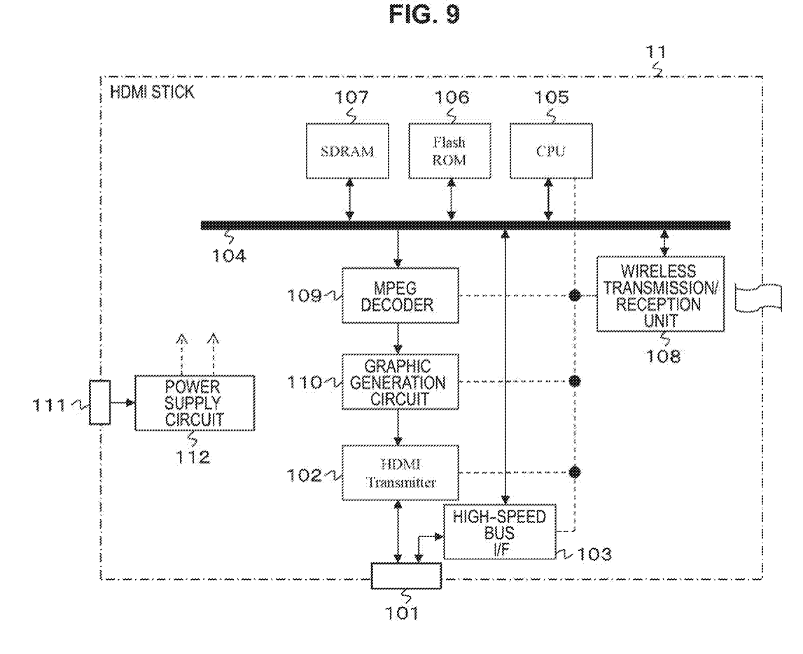

FIG. 9 shows a specific configuration example of the HDMI stick 11. The HDMI stick 11 has an HDMI terminal 101, an HDMI transmission unit (HDMI transmitter) 102, and a high-speed bus interface 103. The HDMI stick 11 also has an internal bus 104, a central processing unit (CPU) 105, a flash read only memory (ROM) 106, a synchronous random access memory (SDRAM) 107, and a wireless transmission/reception unit 108.

The HDMI stick 11 also has a moving picture expert group (MPEG) decoder 109, a graphic generation circuit 110, a DC power supply terminal 111, and a power supply circuit 112. The high-speed bus interface 103, the CPU 105, the flash ROM 106, the SDRAM 107, the wireless transmission/reception unit 108, and the MPEG decoder 109 are connected to the internal bus 104.

The CPU 105 controls an operation of each unit of the HDMI stick 11. The flash ROM 106 stores control software and saves data. The SDRAM 107 provides a work area for the CPU 105. The CPU 105 loads software and data read from the flash ROM 106 into the SDRAM 107, starts up the software, and controls each unit of the HDMI stick 11.

The wireless transmission/reception unit 108 is included in the communication unit 11d (see FIG. 1). The wireless transmission/reception unit 108 connects to a hybridcast content server on a communication network, on the basis of hybridcast-related information (AIT information, etc.) received by the high-speed bus interface 103 through the HDMI terminal 101, acquires a predetermined hybridcast content, and stores the predetermined hybridcast content to the SDRAM 107 through the internal bus 104.

The wireless transmission/reception unit 108, when performing authentication for connection to a hybridcast content server on a communication network, may use an apparatus ID of the television receiver (HDMI sinc) 12, which is supplied from the television receiver 12 as hybridcast-related information, or an individual apparatus ID of the HDMI stick (HDMI source) 11.

The MPEG decoder 109 decodes hybridcast data (MPEG2 stream) acquired through the wireless transmission/reception unit 108 to obtain image data and audio data. The graphic generation circuit 110 overlays graphic data on image data obtained by the MPEG decoder 109, and in addition, displays subtitles or a sub-screen for a hybridcast content, for example, when necessary.

The HDMI transmission unit (HDMI source) 102 sends out baseband hybridcast data (image and/or audio data) from the HDMI terminal 101 by HDMI-compliant communication. The high-speed bus interface 103 is a bidirectional communication path interface including predetermined lines (in this embodiment, a reserve line and an HPD line) of the HDMI transfer path. The high-speed bus interface 103 is inserted between the internal bus 104 and the HDMI terminal 101.

The high-speed bus interface 103 transmits transmission data supplied from the CPU 105, from the HDMI terminal 101 to the other party's apparatus through the HDMI transfer path. The high-speed bus interface 103 also supplies, to the CPU 105, received data from the other party's apparatus that has been received from the HDMI transfer path through the HDMI terminal 101.

The CPU 105 verifies connection to the television receiver 12 using the HPD line 25 of the HDMI transfer path, and thereafter, reads E-EDID information from the television receiver 12 using the DDC 23, and recognizes a video format supported by the television receiver 12. The CPU 105, when transmitting baseband hybridcast data to the television receiver 12, also selects and transmits a video format which can be supported by the television receiver 12, on the basis of the E-EDID information read from the television receiver 12.

At that time, the CPU 105 puts the presentation-mode information of currently transmitted hybridcast data into the control interval 19 of hybridcast image data (video signal) that is to be transmitted by the HDMI transmission unit 102, and transmits the hybridcast image data to the television receiver 12. For example, the hybridcast image data is transmitted to the television receiver 12 using HDMI vendor specific infoframe (hereinafter referred to as “VSIF”) packets or the like.

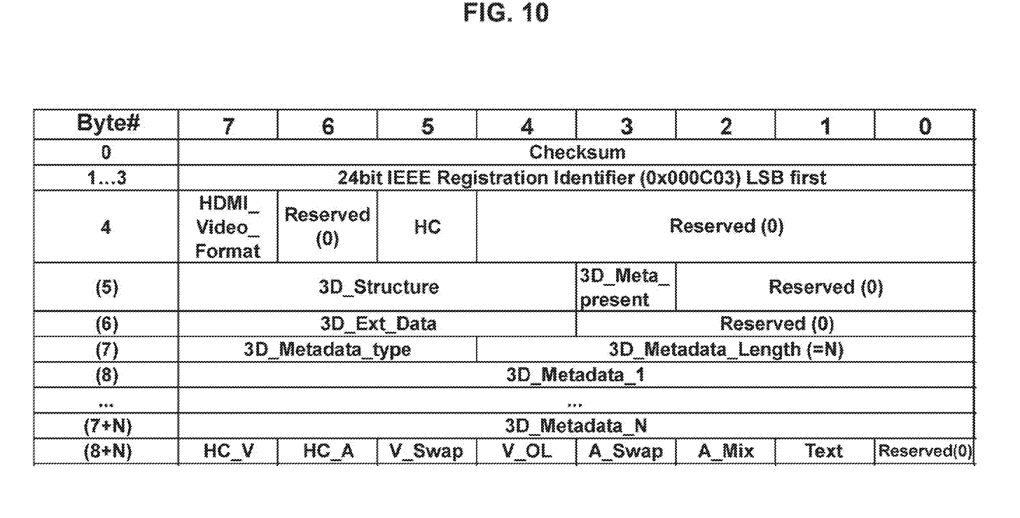

FIG. 10 shows a data structure example of the VSIF packet. In HDMI, the VSIF packet can be used to transfer additional information about an image from a source apparatus to a sinc apparatus. The check sum of data is defined in the 0th byte. In the first to third bytes, provided is information indicating a number “0x000C03” registered for HDMI® that is represented by “24 bit IEEE Registration Identifier (0x000C03) LSB first.”

In the fifth bit of the fourth byte, provided is an “HC” flag indicating whether information about hybridcast data is present in the (8+N)th byte. The “HC” flag, when false (“0”), indicates that information about hybridcast data is not present in the (8+N)th byte, and when true (“1”), indicates that information about hybridcast data is present in the (8+N)th byte.

In the 7th bit of the (8+N)th byte, provided is an “HC_V” flag indicating the presence of hybridcast image data. The “HC_V” flag, when true (“1”), indicates that hybridcast image data is present, and when false (“0”), indicates that hybridcast image data is not present. In the 6th bit, provided is an “HC_A” flag indicating the presence of hybridcast audio data. The “HC_A” flag, when true (“1”), indicates that hybridcast audio data is present, and when false (“0”), indicates that hybridcast audio data is not present.

In the 5th bit, provided is a “V_Swap” flag indicating whether the mode of presentation of a hybridcast image is “switch.” The “V_Swap” flag, when true (“1”), indicates that the presentation mode is “switch,” and when false (“0”), indicates that the presentation mode is not “switch.” In the 4th bit, provided is a “V_OL” flag indicating whether the mode of presentation of a hybridcast image is “overlay.” The “V_OL” flag, when true (“1”), indicates that the presentation mode is “overlay,” and when false (“0”), indicates that the presentation mode is not “overlay.”

In the 3rd bit, provided is an “A_Swap” flag indicating whether the mode of presentation of hybridcast audio is “switch.” The “A_Swap” flag, when true (“1”), indicates that the presentation mode is “switch,” and when false (“0”), indicates that the presentation mode is not “switch.” In the 2nd bit, provided is an “A_Mix” flag indicating whether the mode of presentation of hybridcast audio is “mix.” The “A_MiX” flag, when true (“1”), indicates that the presentation mode is “mix,” and when false (“0”), indicates that the presentation mode is not “mix.”

Moreover, in the 1st bit, provided is a “Text” flag indicating that text data is present as hybridcast data. The “Text” flag, when true (“1”), indicates that text data is present, and when false (“0”), indicates that text data is not present. Note that, as described above, text data is transmitted to the television receiver 12 through a bidirectional communication path which is formed using, for example, predetermined lines (in this embodiment, a reserve line and an HPD line) of the HDMI transfer path.

### Configuration Example of Television Receiver

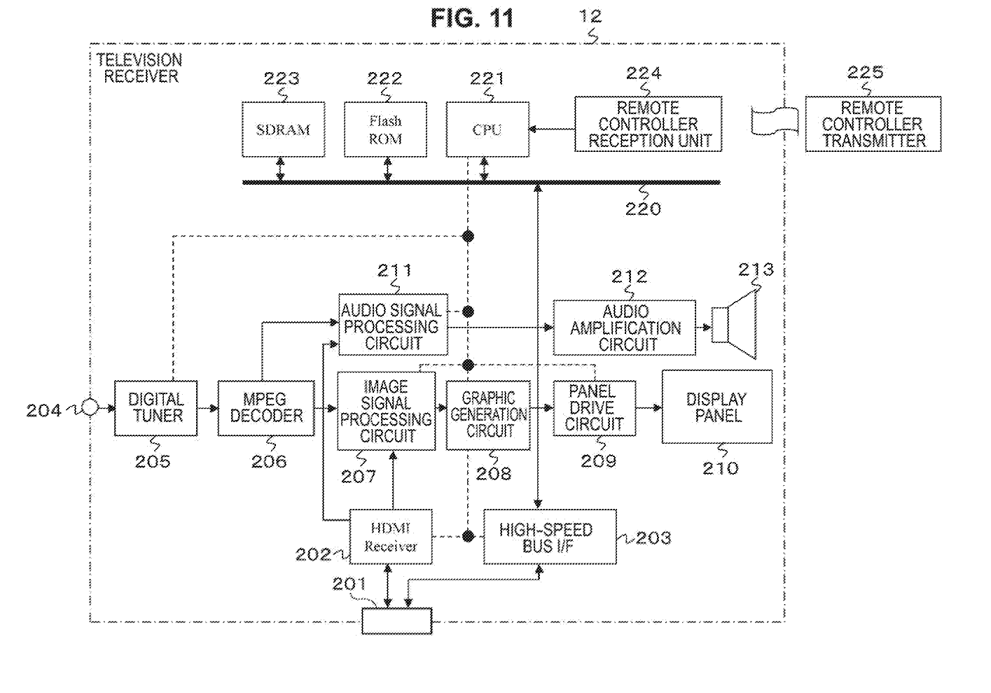

FIG. 11 shows a specific configuration example of the television receiver 12. The television receiver 12 has an HDMI terminal 201, an HDMI reception unit (HDMI receiver) 202, and a high-speed bus interface 203. The television receiver 12 also has an antenna terminal 204, a digital tuner 205, an MPEG decoder 206, an image signal processing circuit 207, a graphic generation circuit 208, a panel drive circuit 209, and a display panel 210.

The television receiver 12 also has an audio signal processing circuit 211, an audio amplification circuit 212, a speaker 213, an internal bus 220, a CPU 221, a flash ROM 222, an SDRAM 223, a remote controller reception unit 224, and a remote controller transmitter 225. The high-speed bus interface 203, the CPU 221, the flash ROM 222, and the SDRAM 223 are connected to the internal bus 220.

The CPU 221 controls an operation of each unit of the television receiver 12. The flash ROM 222 stores control software and saves data including an apparatus ID unique to the television receiver 12. The SDRAM 223 forms a work area for the CPU 221. The CPU 221 loads software and data read from the flash ROM 222 into the SDRAM 223, starts up the software, and controls each unit of the television receiver 12.

The remote controller reception unit 224 receives a remote control signal (remote controller code) transmitted from the remote controller transmitter 225, and supplies the remote control signal to the CPU 221. The CPU 221 controls each unit of the television receiver 12 on the basis of the remote controller code. In a situation where a hybridcast image which prompts the user to operate the display panel 210 is being displayed, the CPU 221 also transmits a remote control signal responding to the user's operation, to the HDMI stick 11 through the high-speed bus interface 203.

The HDMI reception unit (HDMI sinc) 202 receives baseband hybridcast data (image data, audio data) supplied to the HDMI terminal 201 through the HDMI transfer path, by HDMI-compliant communication. As with the above high-speed bus interface 103 of the HDMI stick 11, the high-speed bus interface 203 is an interface for a bidirectional communication path which is formed using predetermined lines (in this embodiment, a reserve line and an HPD line) of the HDMI transfer path.

The high-speed bus interface 203 is inserted between the internal bus 220 and the HDMI terminal 201. The high-speed bus interface 203 transmits transmission data supplied from the CPU 221, from the HDMI terminal 201 to the other party's apparatus through the HDMI transfer path. The high-speed bus interface 203 also supplies, to the CPU 221, received data from the other party's apparatus that has been received from the HDMI transfer path through the HDMI terminal 201.

The antenna terminal 204 is a terminal to which a television broadcast signal received by a reception antenna (not shown) is input. The digital tuner 205 processes a television broadcast signal input to the antenna terminal 204, to extract a partial transport stream (TS), i.e., TS packets of image data and TS packets of audio data, from a predetermined transport stream corresponding to a channel selected by the user.

The digital tuner 205 extracts, from the acquired transport stream, program specific information/service information (PSI/SI), or a digital storage media-command and control (DSM-CC) carousel for data broadcasting, and outputs such information to the CPU 221. A process of extracting a partial TS of any channel from a plurality of transport streams acquired by the digital tuner 205 can be achieved by acquiring information about the packet ID (PID) of that channel from PSI/SI (PAT/PMT).

The digital tuner 205 also extracts an application information table (AIT) from the acquired transport stream. The AIT information is transferred in the section format or data carousel format of a MPEG stream. The transfer schemes in the section format and data carousel format are specified in ARIB STD-B24 ver. 5.8.

The AIT contains application control codes (application_control_code), application acquisition source information (transport_protocol_descriptor), application boundary/access right settings, startup priority, cache control information, server access distribution parameter control information, and the like.

The application control codes are for state control of a hybridcast application. The application control codes are specified as follows: “0x01” indicates that an application will be started (AUTOSTART); “0x02” indicates that an application is startable (PRESENT); “0x04” indicates that an application will be terminated (KILL); and “0x05” indicates that an application will be acquired and held (PREFETCH).

Also, when the “Protocol_id” of the application acquisition source information is “0x0003,” a hybridcast content server on a communication network is specified by “URL_base_byte” and “URL_extension_byte.” For the startup priority information, “autostart_priority_descriptor” is used to specify whether highest priority will be given to data broadcasting or hybridcast application, for each application.

The digital tuner 205 also extracts synchronization clock information (presentation time stamp (PTS)) from a PES packet header so that digital television broadcast data (image data, audio data) is synchronized with hybridcast data (image data, audio data, etc.).

The CPU 221 transmits AIT information, PTS information, and in addition, hybridcast-related information including apparatus ID information unique to the television receiver 12 that is stored in the flash ROM 222 for connection authentication which is performed when connecting to a hybridcast content server on a communication network, to the HDMI stick 11 through the high-speed bus interface 203.

The MPEG decoder 206 decodes packetized elementary stream (PES) packets including TS packets of image data acquired by the digital tuner 205, to acquire the image data. The MPEG decoder 206 also decodes PES packets including TS packets of audio data acquired by the digital tuner 205, to acquire the audio data.

The image signal processing circuit 207 performs an image switching process, an image overlaying process, a scaling process (resolution conversion process), and the like on image data acquired by the MPEG decoder 206 or hybridcast image data received by the HDMI reception unit 202, when necessary.

The image signal processing circuit 207, when there is hybridcast image data, performs the image switching process or the image overlaying process on the basis of the presentation-mode information of the hybridcast image. As described above, the presentation-mode information of a hybridcast image is inserted in a VSIF packet inserted in the blanking period of hybridcast image data. The CPU 221 extracts the presentation-mode information from the VSIF packet, and controls an operation of the image signal processing circuit 207 on the basis of the presentation-mode information.

For example, when the “V_Swap” flag is true (“1”), i.e., indicates “switch,” the image signal processing circuit 207 performs the image switching process to switch output image data from broadcast image data to hybridcast image data. When the “V_OL” flag is true (“1”), i.e., indicates “overlay,” the image signal processing circuit 207 performs the image overlaying process to output image data for displaying an image in which a hybridcast image is overlaid on a broadcast image.

The graphic generation circuit 208 performs a graphic data overlaying process on image data output from the image signal processing circuit 207 when necessary. The panel drive circuit 209 drives the display panel 210 on the basis of the image data output from the graphic generation circuit 208. Therefore, on the display panel 210, displayed is a broadcast image corresponding to a channel selected by the user, or an image in which a hybridcast image is overlaid on the broadcast image, or a hybridcast image. The display panel 210 includes, for example, a liquid crystal display (LCD), an organic electro luminescence (organic EL), or the like.

The audio signal processing circuit 211 performs processes, such as an audio switching process, an audio mixing process, D/A conversion, and the like, on audio data acquired by the MPEG decoder 206, or hybridcast audio data received by the HDMI reception unit 202, when necessary.

The audio signal processing circuit 211, when there is hybridcast audio data, performs the audio switching process or the audio overlaying process on the basis of the presentation-mode information of hybridcast audio. As described above, the presentation-mode information of hybridcast audio is inserted in a VSIF packet inserted in the blanking period of hybridcast image data. The CPU 221 extracts the presentation-mode information from the VSIF packet, and controls an operation of the audio signal processing circuit 207 on the basis of the presentation-mode information.

For example, when the “A_Swap” flag is true (“1”), i.e., indicates “switch,” the audio signal processing circuit 211 performs the audio switching process to switch output audio data from broadcast audio data to hybridcast audio data. Also, when the “V_Mix” flag is true (“1”), i.e., indicates “mix,” the audio signal processing circuit 211 performs the audio mixing process to output audio data for obtaining audio which is a mixture of broadcast audio and hybridcast audio.

The audio amplification circuit 212 amplifies an audio signal output from the audio signal processing circuit 211, and supplies the resultant audio signal to the speaker 213. Therefore, the speaker 213 outputs broadcast audio corresponding to a channel selected by the user, or audio which is a mixture of the broadcast audio with hybridcast audio, or hybridcast audio.

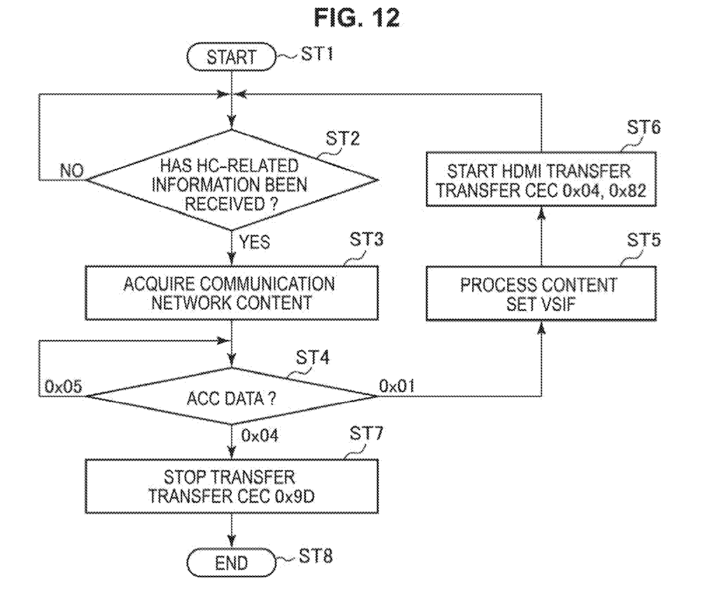

Next, a process which is performed in the HDMI stick (source apparatus) 11 when connecting to the television receiver (sinc apparatus) 12, in the AV system 10 shown in FIG. 1, will be described with reference to a flowchart of FIG. 12.

The HDMI stick 11 starts the process in step ST1, and thereafter, proceeds to step ST2. In step ST2, the HDMI stick 11 determines whether hybridcast-related information has been received. When hybridcast-related information has not been received, the HDMI stick 11 returns to step ST2.

Meanwhile, when hybridcast-related information has been received, the HDMI stick 11 connects to a hybridcast content server on a communication network that is specified in the AIT information of the hybridcast-related information received in step ST2, to acquire a hybridcast content, in step ST3.

Note that the HDMI stick 11, when performing authentication for connection to a hybridcast content server on a communication network, may use the apparatus ID of the television receiver 12 in the hybridcast-related information received in step ST2, or the individual apparatus ID of the HDMI stick 11.

Next, in step ST4, the HDMI stick 11 determines the application control code (ACC) of the AIT information received in step ST2. When the application control code (ACC) is application startup (AUTOSTART: 0x01), the HDMI stick 11 processes the hybridcast content acquired in step ST2 to acquire hybridcast data (image data, audio data), and sets the presentation-mode information of the hybridcast data into a VS InfoFrame packet, in step ST5.

Next, in step ST6, the HDMI stick 11 transmits the “Image View On: 0x04” and “Active Source: 0x82” commands in HDMI CEC to the CEC line 24 to start transmitting hybridcast data (image data, audio data) from the data transmission unit (HDMI transmission unit) 11b, and returns to step ST2.

Also, when, in step ST4, the application control code (ACC) is application startable (PREFETCH: 0x05), the HDMI stick 11 returns to the process of step ST4. Also, when the application control code (ACC) is application termination (KILL: 0x04), the HDMI stick 11 ends transmission of the hybridcast data and the VSIF packet, and transmits the “Inactive Source: 0x9D” command in HDMI CEC to the CEC line 24 in step ST7, and proceeds to step ST8, where the process is ended.

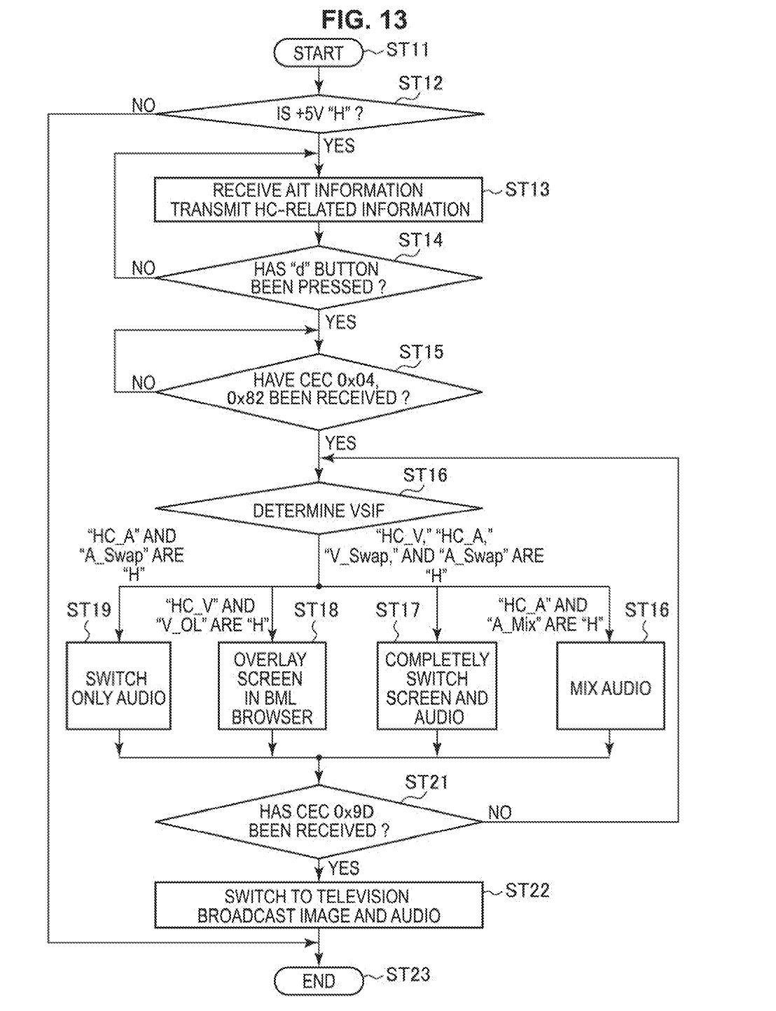

Next, a process which is performed in the television receiver (sinc apparatus) 12 when connecting to the HDMI stick (source apparatus) 11, in the AV system 10 shown in FIG. 1, will be described with reference to a flowchart of FIG. 13.

The television receiver 12 starts the process in step ST11, and thereafter, proceeds to step ST12. In step ST12, the television receiver 12 determines whether the HDMI stick 11 is connected to the HDMI terminal 201, using the DC voltage of the power supply line (+5V line) 26.

When the power supply line 26 is low (“L”), the television receiver 12 determines that the HDMI stick 11 is not connected, and proceeds to step ST23, where the process is ended. Meanwhile, when the power supply line 26 is high (“H”), the television receiver 12 determines that the HDMI stick 11 is connected, and proceeds to step ST13.

In step ST13, the television receiver 12 transmits the AIT information and the PTS information received by the broadcast reception unit 12f, and in addition, hybridcast-related information including, for example, apparatus ID information unique to the television receiver 12 stored in the flash ROM 222 for performing connection authentication when connecting to a server on a communication network, to the HDMI stick 11 through the high-speed bus interface 103.

Next, in step ST14, the television receiver 12 determines whether the data broadcast “d” button of the remote controller transmitter 225 has been pressed. If the “d” button has not been pressed, the television receiver 12 returns to step ST13. Meanwhile, if the “d” button has been pressed, the television receiver 12 proceeds to step ST15. In step ST15, the television receiver 12 determines whether the “Image View On: 0x04” and “Active Source: 0x82” commands in HDMI CEC have been received in the CEC line 24. If the HDMI CEC commands have not been received, the television receiver 12 returns to step ST15.

Meanwhile, if the HDMI CEC commands have been received, the television receiver 12 determines that transmission of hybridcast data (image data, audio data) from the HDMI stick 11 has been started, and proceeds to step ST16. In step ST16, the television receiver 12 determines the presentation-mode information of the hybridcast data inserted in VSIF transmitted during the control period 19.

When all of the 7th to 5th bits and the 3rd bit in the (8+N)th byte of VSIF are “1,” the television receiver 12 determines that hybridcast image and audio have been transmitted, and the mode of presentation in which an image and audio is completely switched to an image and audio of digital television broadcast has been selected, and proceeds to step ST17. In step ST17, the television receiver 12 switches an image and audio presented by the presentation unit 12g to the hybridcast image and audio, and proceeds to step ST21.

When the 7th bit and the 4th bit in the (8+N)th byte of “VSIF are “1,” the television receiver 12 determines that only a hybridcast image has been transmitted, and the mode of presentation in which a hybridcast image is overlaid on a digital television broadcast image has been selected, and proceeds to step ST18. In step ST18, a process of overlaying the hybridcast image on a digital television broadcast image is performed by the data processing unit 12d, and the resultant image is displayed on the presentation unit 12g, and the television receiver 12 proceeds to step ST21.

Also, when the 6th bit and the 3rd bit in the (8+N)th byte of “VSIF are “1,” the television receiver (sinc apparatus) 12 determines that only hybridcast audio has been transmitted, and the mode of presentation in which audio is switched from digital television broadcast audio to hybridcast audio has been selected, and proceeds to step ST19. In step ST19, audio of the presentation unit 12g is switched to hybridcast audio, and the television receiver 12 proceeds to step ST21.

Moreover, when the 6th bit and the 2nd bit in the (8+N)th byte of “VSIF are “1,” the television receiver 12 determines that only hybridcast audio has been transmitted, and the mode of presentation in which digital television broadcast audio is mixed with hybridcast audio has been selected, and proceeds to step ST20. In step ST20, the television receiver 12 mixes digital television broadcast audio with hybridcast audio, outputs the resultant audio to the presentation unit 12g, and proceeds to step ST21.

Next, in step ST21, the television receiver 12 determines whether the “Inactive Source: 0x9D” command of HDMI CEC has been received on the CEC line 24. If the HDMI CEC command has not been received, the television receiver 12 determines that a hybridcast image and audio continues to be presented, and returns to step ST16.

Meanwhile, when the HDMI CEC command has been received, the television receiver 12 determines that the transfer of hybridcast data (image data, audio data) from the HDMI stick 11 has been ended, and proceeds to step ST22. In step ST22, the television receiver 12 switches an image and audio presented on the presentation unit 12g to a digital television broadcast image and audio received by the broadcast reception unit 12f of the television receiver 12, and proceeds to step ST23, in which the process is ended.

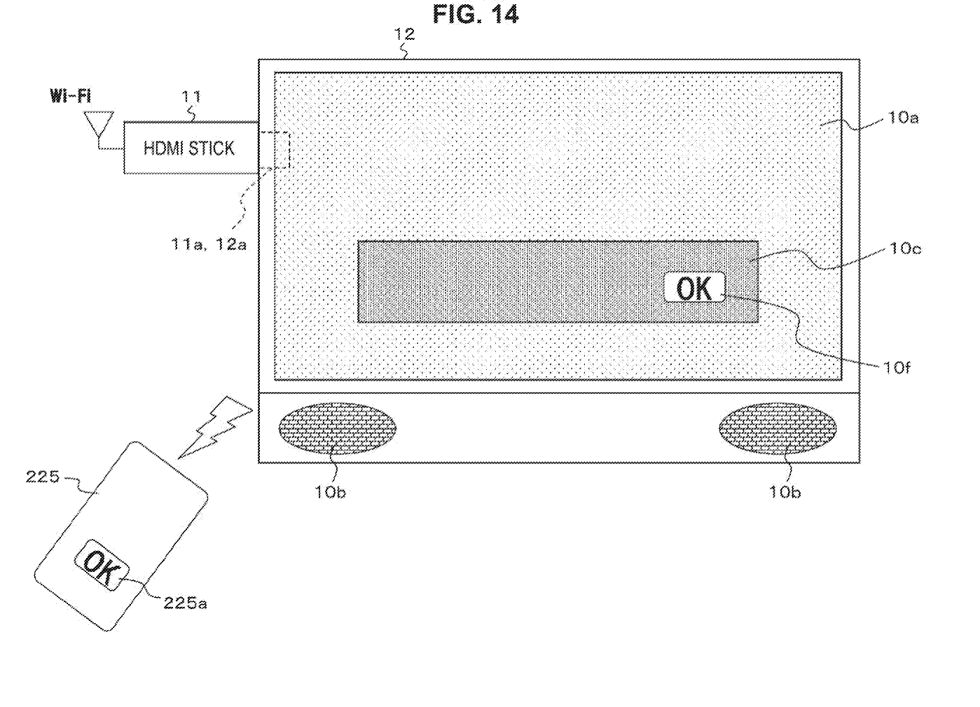

FIG. 14 shows an example in which the hybridcast image 10c produced by the HDMI stick 11 is overlaid and presented on the broadcast image 10a of the television receiver 12, and in addition, a hybridcast image operation display 10f with which a hybridcast service prompts the user to operate is presented.

The user (not shown) uses the remote controller transmitter 225 of the television receiver 12 to operate a remote controller button 225a according to the hybridcast image operation display 10f. A remote controller code sent from the remote controller transmitter 225 is received by the remote controller reception unit 224 of the television receiver 12, and thereafter, is transmitted to the HDMI stick 11 through the CPU 221, the internal bus 220, the high-speed bus interface 203 or the CEC line 24, and the HDMI terminal 201 (see FIG. 11).

In the HDMI stick 11, the remote controller code received from the television receiver 12 is input to the CPU 105 through the HDMI terminal 101, the high-speed bus interface 103 or the CEC line 24, and the internal bus 104 (see FIG. 9). The CPU 105 decrypts the received remote controller code, and when determining that the user's operation is directed to the hybridcast image operation display 10f produced by the graphic generation circuit 110 of the HDMI stick 11, transitions to the next hybridcast screen or operation on the basis of the specifications of the hybridcast service.

Thus, the user of the television receiver 12 can use the remote controller transmitter 225 to operate the hybridcast image 10c of the HDMI stick 11.

As described above, in the AV system 10 of FIG. 1, the HDMI stick 11 transmits, to the television receiver 12, hybridcast data acquired on the basis of hybridcast-related information sent from the television receiver 12, and presentation-mode information selected on the basis of the hybridcast-related information. Therefore, for example, hybridcast data can be satisfactorily transmitted.

Also, in the AV system 10 shown in FIG. 1, the television receiver 12 transmits hybridcast-related information to the HDMI stick 11, receives, from the HDMI stick 11, hybridcast data acquired on the basis of the hybridcast-related information, and presentation-mode information selected on the basis of the hybridcast-related information, and processes the hybridcast data on the basis of the presentation-mode information to obtain presentation data. Therefore, for example, hybridcast data can be satisfactorily received, and presentation data can be appropriately obtained.

### 2. Variations

Although, in the above embodiments, the HDMI stick 11 transmits the presentation-mode information of hybridcast data to the television receiver 12 with the presentation-mode information of hybridcast data being inserted in the VSIF packet provided in the blanking period of hybridcast image data, the present technology is not limited to this. For example, the HDMI stick 11 may transmit the presentation-mode information to the television receiver 12 with the presentation-mode information being inserted in another data packet provided in the blanking period of hybridcast image data.

Also, for example, the HDMI stick 11 may transmit the presentation-mode information to the television receiver 12 using the CEC line 24, which is a control data line of the HDMI transfer path. Moreover, for example, the HDMI stick 11 may transmit the presentation-mode information to the television receiver 12 through a bidirectional communication path including predetermined lines (e.g., a reserve line and an HPD line) of the HDMI transfer path.

Also, in the above embodiments, an example in which the HDMI transfer path is used is illustrated. However, as the baseband digital interface, a Mobile High-Definition Link (MHL) interface, a Digital Visual Interface (DVI) interface, a wireless interface using Wi-Fi wireless radio of 60-GHz extremely high frequency, or the like may be employed in addition to HDMI. The present technology is similarly applicable to a case where these digital interfaces are used for transfer of hybridcast data.

Also, although, in the above embodiments, an example is illustrated in which the HDMI stick 11 is employed as a transmission apparatus (source apparatus) and the television receiver 12 is employed as a reception apparatus (sinc apparatus), the present technology is, of course, similarly applicable to a case where other transmission apparatuses and reception apparatuses are employed.

Additionally, the present technology may also be configured as below.

(1) A transmission apparatus including:

an information reception unit configured to receive hybridcast-related information transmitted from an external apparatus through a transfer path;

a communication unit configured to connect to a hybridcast content server on a communication network on the basis of the hybridcast-related information received by the information reception unit, and acquire hybridcast data;

a data transmission unit configured to transmit the hybridcast data acquired by the communication unit to the external apparatus through the transfer path; and

a presentation-mode information transmission unit configured to transmit presentation-mode information of the hybridcast data transmitted by the data transmission unit, the presentation-mode information being selected on the basis of the hybridcast-related information received by the information reception unit, to the external apparatus through the transfer path.

(2) The transmission apparatus according to (1),

wherein the data transmission unit transmits the hybridcast data to the external apparatus through the transfer path using differential signals.

(3) The transmission apparatus according to (1) or (2),

wherein the presentation-mode information transmission unit transmits the presentation-mode information of the hybridcast data transmitted by the data transmission unit, to the external apparatus, with the presentation-mode information being inserted in a blanking period of hybridcast image data transmitted by the data transmission unit.

(4) The transmission apparatus according to (1) or (2),

wherein the presentation-mode information transmission unit transmits the presentation-mode information of the hybridcast data transmitted by the data transmission unit, to the external apparatus through a control data line of the transfer path.

(5) The transmission apparatus according to (1) or (2),

wherein the presentation-mode information transmission unit transmits the presentation-mode information of the hybridcast data transmitted by the data transmission unit, to the external apparatus through a bidirectional communication path including a predetermined line of the transfer path.

(6) The transmission apparatus according to (5),

wherein the bidirectional communication path is a pair of differential transfer paths, and at least one of the pair of differential transfer paths has a function of being notified of a connection status by the external apparatus using a direct current bias potential.

(7) The transmission apparatus according to any of (1) to (6),

wherein the presentation-mode information of the hybridcast data includes at least either switch information indicating that presentation is to be switched from presentation based on digital broadcast data received by the external apparatus to presentation based on the hybridcast data, or combination information indicating that presentation based on the hybridcast data is to be combined with presentation based on digital broadcast data received by the external apparatus.

(8) The transmission apparatus according to any of (1) to (7),

wherein the hybridcast-related information includes at least application information table (AIT) information and presentation time stamp (PTS) information.

(9) A hybridcast data transmission method including:

an information reception step of receiving hybridcast-related information transmitted from an external apparatus through a transfer path;

a data acquisition step of connecting to a hybridcast content server on a communication network on the basis of the received hybridcast-related information, and acquiring hybridcast data;

a data transmission step of transmitting the acquired hybridcast data to the external apparatus through the transfer path using a data transmission unit; and

a presentation-mode information transmission step of transmitting presentation-mode information of the hybridcast data transmitted in the data transmission step, the presentation-mode information being selected on the basis of the received hybridcast-related information, to the external apparatus through the transfer path.

(10) A reception apparatus including:

an information transmission unit configured to transmit hybridcast-related information to an external apparatus through a transfer path;

a data reception unit configured to receive hybridcast data acquired on the basis of the hybridcast-related information from the external apparatus through the transfer path;

a presentation-mode information reception unit configured to receive presentation-mode information of the hybridcast data received by the data reception unit, the presentation-mode information being selected on the basis of the hybridcast-related information, from the external apparatus through the transfer path; and

a data processing unit configured to process the hybridcast data received by the data reception unit, on the basis of the presentation-mode information received by the presentation-mode information reception unit, to obtain presentation data.

(11) The reception apparatus according to (10),

wherein the hybridcast-related information includes at least application information table (AIT) information and presentation time stamp (PTS) information.

(12) The reception apparatus according to (10) or (11),

wherein the data reception unit receives the hybridcast data from the external apparatus through the transfer path using differential signals.

(13) The reception apparatus according to any of (10) to (12),

wherein the presentation-mode information reception unit extracts the presentation-mode information of the hybridcast data received by the data reception unit, from a blanking period of hybridcast image data received by the data reception unit.

(14) The reception apparatus according to any of (10) to (12),

wherein the presentation-mode information reception unit receives the presentation-mode information of the hybridcast data received by the data reception unit, from the external apparatus through a control data line of the transfer path.

(15) The reception apparatus according to any of (10) to (12),

wherein the presentation-mode information reception unit receives the presentation-mode information of the hybridcast data received by the data reception unit, from the external apparatus through a bidirectional communication path including a predetermined line of the transfer path.

(16) The reception apparatus according to (15),

wherein the bidirectional communication path is a pair of differential transfer paths, and at least one of the pair of differential transfer paths has a function of notifying the external apparatus of a connection status using a direct current bias potential.

(17) The reception apparatus according to any of (10) to (16),

wherein the presentation-mode information of the hybridcast data includes at least either switch information indicating that presentation is to be switched from presentation based on received digital broadcast data to presentation based on the hybridcast data, or combination information indicating that presentation based on the hybridcast data is to be combined with presentation based on received digital broadcast data.

(18) A hybridcast data reception method including:

an information transmission step of transmitting hybridcast-related information extracted from a predetermined data broadcast signal to an external apparatus through a transfer path;

a data reception step of receiving hybridcast data acquired on the basis of the hybridcast-related information from the external apparatus through the transfer path, using a data reception unit;

a presentation-mode information reception step of receiving presentation-mode information of the received hybridcast data, the presentation-mode information being selected on the basis of the hybridcast-related information, from the external apparatus through the transfer path; and

a data processing step of processing the hybridcast data received by the data reception unit, on the basis of the received presentation-mode information, to obtain presentation data.

### REFERENCE SIGNS LIST

10 AV system
11 HDMI stick
11a HDMI terminal
11b data transmission unit
11c information reception unit
11d communication unit
11e presentation-mode information transmission unit
12 television receiver
12a HDMI terminal
12b data reception unit
12c information transmission unit
12d data processing unit
12e presentation-mode information reception unit
12f broadcast reception unit
12g presentation unit
14 active image interval
15 horizontal blanking interval
16 vertical blanking interval
17 video data interval
18 data island interval
19 control interval
21 HDMI transmitter
22 HDMI receiver
23 DDC line
24 CEC line
25 HPD line
26 power supply line
27 reserve line
101 HDMI terminal
102 HDMI transmission unit
103 high-speed bus interface
104 internal bus
105 CPU
106 flash ROM
107 SDRAM
108 wireless transmission/reception unit
109 MPEG decoder
110 graphic generation circuit
111 DC power supply terminal
112 power supply circuit
201 HDMI terminal
202 HDMI reception unit
203 high-speed bus interface
204 antenna terminal
205 digital tuner
206 MPEG decoder
207 image signal processing circuit
208 graphic generation circuit
209 panel drive circuit
210 display panel
211 audio signal processing circuit
212 audio amplification circuit
213 speaker
220 internal bus
221 CPU
222 flash ROM
223 SDRAM
224 remote controller reception unit
225 remote controller transmitter

1. A transmission apparatus comprising:
an information reception unit configured to receive hybridcast-related information transmitted from an external apparatus through a transfer path;
a communication unit configured to connect to a hybridcast content server on a communication network on the basis of the hybridcast-related information received by the information reception unit, and acquire hybridcast data;
a data transmission unit configured to transmit the hybridcast data acquired by the communication unit to the external apparatus through the transfer path; and
a presentation-mode information transmission unit configured to transmit presentation-mode information of the hybridcast data transmitted by the data transmission unit, the presentation-mode information being selected on the basis of the hybridcast-related information received by the information reception unit, to the external apparatus through the transfer path.

2. The transmission apparatus according to claim 1,
wherein the data transmission unit transmits the hybridcast data to the external apparatus through the transfer path using differential signals.

3. The transmission apparatus according to claim 1,
wherein the presentation-mode information transmission unit transmits the presentation-mode information of the hybridcast data transmitted by the data transmission unit, to the external apparatus, with the presentation-mode information being inserted in a blanking period of hybridcast image data transmitted by the data transmission unit.

4. The transmission apparatus according to claim 1,
wherein the presentation-mode information transmission unit transmits the presentation-mode information of the hybridcast data transmitted by the data transmission unit, to the external apparatus through a control data line of the transfer path.

5. The transmission apparatus according to claim 1,
wherein the presentation-mode information transmission unit transmits the presentation-mode information of the hybridcast data transmitted by the data transmission unit, to the external apparatus through a bidirectional communication path including a predetermined line of the transfer path.

6. The transmission apparatus according to claim 5,
wherein the bidirectional communication path is a pair of differential transfer paths, and at least one of the pair of differential transfer paths has a function of being notified of a connection status by the external apparatus using a direct current bias potential.

7. The transmission apparatus according to claim 1,
wherein the presentation-mode information of the hybridcast data includes at least either switch information indicating that presentation is to be switched from presentation based on digital broadcast data received by the external apparatus to presentation based on the hybridcast data, or combination information indicating that presentation based on the hybridcast data is to be combined with presentation based on digital broadcast data received by the external apparatus.

8. The transmission apparatus according to claim 1,
wherein the hybridcast-related information includes at least application information table (AIT) information and presentation time stamp (PTS) information.

9. A hybridcast data transmission method comprising:
an information reception step of receiving hybridcast-related information transmitted from an external apparatus through a transfer path;
a data acquisition step of connecting to a hybridcast content server on a communication network on the basis of the received hybridcast-related information, and acquiring hybridcast data;
a data transmission step of transmitting the acquired hybridcast data to the external apparatus through the transfer path using a data transmission unit; and
a presentation-mode information transmission step of transmitting presentation-mode information of the hybridcast data transmitted in the data transmission step, the presentation-mode information being selected on the basis of the received hybridcast-related information, to the external apparatus through the transfer path.

10. A reception apparatus comprising:
an information transmission unit configured to transmit hybridcast-related information to an external apparatus through a transfer path;
a data reception unit configured to receive hybridcast data acquired on the basis of the hybridcast-related information from the external apparatus through the transfer path;
a presentation-mode information reception unit configured to receive presentation-mode information of the hybridcast data received by the data reception unit, the presentation-mode information being selected on the basis of the hybridcast-related information, from the external apparatus through the transfer path; and
a data processing unit configured to process the hybridcast data received by the data reception unit, on the basis of the presentation-mode information received by the presentation-mode information reception unit, to obtain presentation data.

11. The reception apparatus according to claim 10,
wherein the hybridcast-related information includes at least application information table (AIT) information and presentation time stamp (PTS) information.

12. The reception apparatus according to claim 10,
wherein the data reception unit receives the hybridcast data from the external apparatus through the transfer path using differential signals.

13. The reception apparatus according to claim 10,
wherein the presentation-mode information reception unit extracts the presentation-mode information of the hybridcast data received by the data reception unit, from a blanking period of hybridcast image data received by the data reception unit.

14. The reception apparatus according to claim 10,
wherein the presentation-mode information reception unit receives the presentation-mode information of the hybridcast data received by the data reception unit, from the external apparatus through a control data line of the transfer path.

15. The reception apparatus according to claim 10,
wherein the presentation-mode information reception unit receives the presentation-mode information of the hybridcast data received by the data reception unit, from the external apparatus through a bidirectional communication path including a predetermined line of the transfer path.

16. The reception apparatus according to claim 15,
wherein the bidirectional communication path is a pair of differential transfer paths, and at least one of the pair of differential transfer paths has a function of notifying the external apparatus of a connection status using a direct current bias potential.

17. The reception apparatus according to claim 10,
wherein the presentation-mode information of the hybridcast data includes at least either switch information indicating that presentation is to be switched from presentation based on received digital broadcast data to presentation based on the hybridcast data, or combination information indicating that presentation based on the hybridcast data is to be combined with presentation based on received digital broadcast data.

18. A hybridcast data reception method comprising:
an information transmission step of transmitting hybridcast-related information extracted from a predetermined data broadcast signal to an external apparatus through a transfer path;
a data reception step of receiving hybridcast data acquired on the basis of the hybridcast-related information from the external apparatus through the transfer path, using a data reception unit;
a presentation-mode information reception step of receiving presentation-mode information of the received hybridcast data, the presentation-mode information being selected on the basis of the hybridcast-related information, from the external apparatus through the transfer path; and
a data processing step of processing the hybridcast data received by the data reception unit, on the basis of the received presentation-mode information, to obtain presentation data.
